(19) United States
(12) Patent Application Publication
(10) Pub. No.: US 2009/0219120 A1
(43) Pub. Date: Sep. 3, 2009

(54) ELECTROMAGNET DEVICE

(75) Inventors: Masaaki Abe, Kumamoto-shi (JP); Tatsuo Shinoura, Koshi-shi (JP)

Correspondence Address: OSHA LIANG L.L.P., TWO HOUSTON CENTER, 909 FANNIN, SUITE 3500, HOUSTON, TX, 77010, US

(73) Assignee: OMRON Corporation, Kyoto-shi (JP)

(21) Appl. No.: 12/369,063

(22) Filed: Feb. 11, 2009

(30) Foreign Application Priority Data
Feb. 29, 2008 (JP) 2008-049989

(51) Int. Cl. H01H 9/00

(52) U.S. Cl. 335/203

(57) ABSTRACT

An electromagnet device has a movable iron piece having an end that is operable to contact and separate to and from a magnetic pole portion of an iron core. The movable iron piece rotates based on magnetization and demagnetization of a coil wound around the iron core. A tapered surface is formed on at least one end of an attraction surface of the movable iron piece, which attracts to and separates from the magnetic pole portion of the iron core. At least one contacting portion that is in flush with and continuous to the attraction surface and in contact with the magnetic pole portion of the iron core is arranged in a projecting manner on the tapered surface.

### BACKGROUND OF THE INVENTION

1. Technical Field

The present invention relates to an electromagnet device, in particular, to a shape of a movable iron piece of the electromagnet device used in an electromagnetic relay

2. Related Art

Conventionally, for a movable iron core of an electromagnet device, the electromagnet device in which an end of the movable iron piece, which rotates based on magnetization and demagnetization of a coil wound around an iron core, is arranged to contact with or separate from a magnetic pole portion of the iron core, and a movable contact spring piece integral with the movable iron piece is driven to open/close a contacting point is known (refer to, for example, Japanese Patent Publication No. 3413847).

However, the movable iron piece of the electromagnet device has both ends contacting a magnetic pole portion of the iron core formed to a flat surface, where an attraction surface of the movable iron piece contacts the magnetic pole portion of the iron core in area or in line. When the movable iron piece and the magnetic pole portion of the iron core are in contact in area or in line, an attractive force the movable iron piece receives from the electromagnet is greatly influenced by a contacting state such as a contacting angle of the movable iron piece and the magnetic pole portion of the iron core. Thus, a holding force of the movable iron piece varies if the contacting state varies, and thus an opening force required when the movable iron piece opens from the iron core varies, and a stable operation property becomes difficult to obtain. Furthermore, an operation failure, and inoperability tend to easily occur due to an abrasive powder generated when both ends of the movable iron piece attract to or separate from the magnetic pole portion of the iron core, and other foreign substances.

In order to solve such problems, a projection 2 is arranged in a projecting manner at an end of a movable iron piece 1 to be attracted to the magnetic pole portion of the iron core, as shown in FIGS. 6A and 6B. When forming the projection 2, the end of the movable iron piece 1 is normally positioned in a die formed with a mortar-shaped recess, and the projection 2 is formed through extrusion processing.

However, since oil, dust, and the like easily attach to an inside of the recess of the die, a height dimension M of the projection 2 tends to vary. In particular, variations in the height dimension M become relatively large if the height dimension M of the projection 2 is very small. Thus, an adjustment task in an assembly step requires great trouble as variations in an operation property due to the variations in the height dimension M is to be resolved, and a production cost tends to increase.

As shown in FIGS. 6C and 6D, a proposal has been made to arrange the projection 2 in a projecting manner at a step 3 one step lower than an attraction surface of a movable iron piece 1. However, in order to form the step 3 of one step lower, a large piece of equipment is required according to an area and a crushing amount of the step 3, and furthermore, a processing man-hour increases and the production cost increases.

### SUMMARY

In view of the above problems, it is an object of the present invention to provide an electromagnet device in which the height dimension of a contacting portion of the movable iron piece does not have variations, an adjustment of an operation property is unnecessary, and a production cost is low.

To solve the above problem, an electromagnet device according to the present invention relates to an electromagnet device for contacting and separating an end of a movable iron piece, which rotates based on magnetization and demagnetization of a coil wound around an iron core, to and from a magnetic pole portion of the iron core; wherein a tapered surface is formed on at least one end of an attraction surface of the movable iron piece, which attracts to and separates from the magnetic pole portion of the iron core, and at least one contacting portion being in flush with and continuous to the attraction surface and in contact with the magnetic pole portion of the iron core is arranged in a projecting manner on the tapered surface.

According to the present invention, a discontinuous recess does not need to be formed in the die as in the related art since the contacting portion of the movable iron piece is formed in flush with and continuous to the attraction surface. Therefore, the device is less susceptible to an influence of oil, dust, or the like, and the variations in the height dimension is less likely to occur, and thus the operation property of the movable iron piece can be improved, the adjustment task in the assembly step is unnecessary, and the production cost can be reduced.

Another electromagnet device according to the present invention may relate to an electromagnet device for contacting and separating an end of a movable iron piece, which rotates based on magnetization and demagnetization of a coil wound around an iron core, to and from a magnetic pole portion of the iron core; wherein a tapered surface is formed on at least one end of an attraction surface of the movable iron piece, which attracts to and separates from the magnetic pole portion of the iron core, and at least one recess is formed at the tapered surface to arrange at least one contacting portion being in flush with and continuous to the attraction surface and in contact with the magnetic pole portion of the iron core.

According to the present invention, effects similar to the above-described aspects of the invention are obtained, and a movable iron piece having a contacting portion of various shapes can be obtained, whereby an application can be extended.

As an embodiment according to the present invention, the tapered surface may be an are-surface.

According to this embodiment, a degree of freedom in designing the die can be increased, and manufacturing of the die is facilitated.

As another embodiment according to the present invention, a contacting portion being in flush with and continuous to the attraction surface may be arranged in a projecting manner at the tapered surface formed at both ends of the attraction surface of the movable iron piece.

According to this embodiment, an electromagnet device having a seesaw type movable iron piece is obtained, and the application can be extended.

### BRIEF DESCRIPTION OF THE DRAWINGS

FIG. 1 is a cross-sectional view showing a case where an electromagnet device of the present invention is applied to an electromagnetic relay;

FIGS. 2A to 2D show a perspective view, a plan view, a front view, and a partially enlarged view, each showing a movable iron piece incorporated in the electromagnetic relay shown in FIG. 1;

FIG. 3A shows a schematic view for describing a shape of a contacting portion of the movable iron piece, and FIG. 3B shows a partially enlarged cross-sectional view showing a state in which a contacting portion of the movable iron piece is brought into contact with a magnetic pole portion of an iron core;

FIGS. 4A to 4E show a perspective view, a plan view, a front view, a bottom view, and a right side view, each showing a state in which a pushing spring is assembled to the movable iron piece shown in FIG. 2;

FIGS. 5A to 5D are partial perspective views each showing a movable iron piece according to a second, third, fourth, and fifth embodiments; and

FIGS. 6A and 6B show a perspective view and a partially enlarged cross-sectional view each showing a movable iron piece according to a related art, and FIGS. 6C and 6D show a perspective view and a partially enlarged cross-sectional view each showing a movable iron piece according to another related art.

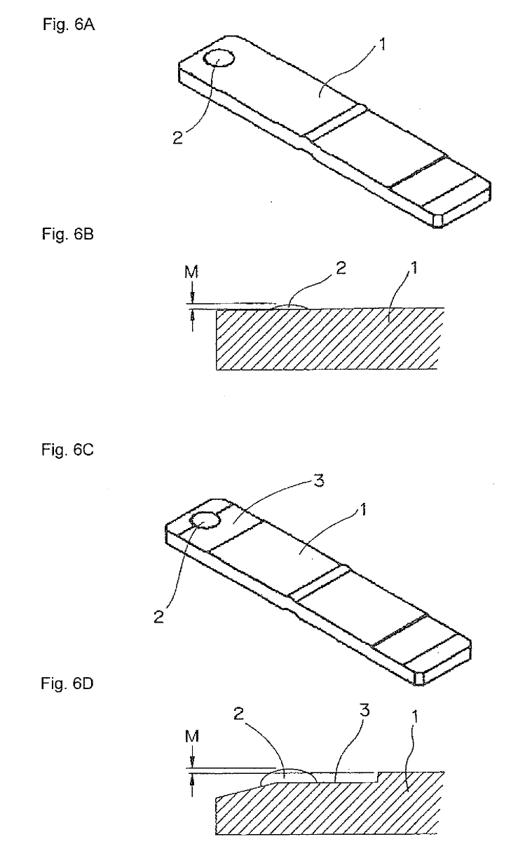

### DETAILED DESCRIPTION

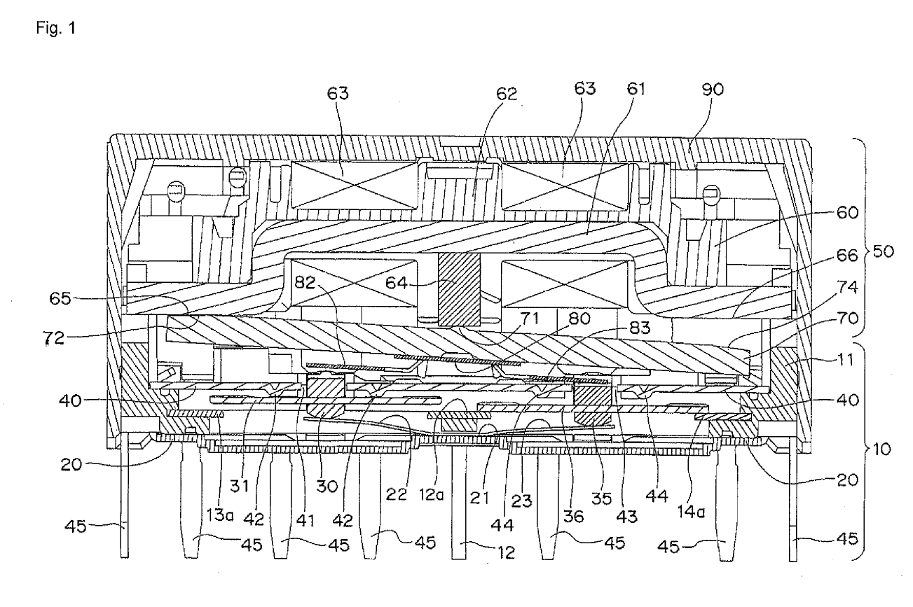

An embodiment of the present invention will be described according to the accompanied drawings of FIGS. 1 to 5.

As shown in FIGS. 1 to 4, an electromagnet device 50 according to a first embodiment is a case applied to a self-returning type electromagnetic relay used to open/close a high frequency circuit.

In other words, the electromagnetic relay according to the present embodiment has the electromagnet device 50, in which a movable iron piece 70 is assembled to an electromagnet block 60, incorporated in a space formed by fitting and integrating a case 90 to a base block 10.

The base block 10 is obtained by sandwiching a base 11, which incorporates a pair of movable contacting point blocks 30, 35, from above and below by a lower shield plate 20 and an upper shield plate 40.

The base 11 is arranged with a common fixed contacting point portion 12a, a constantly opened fixed contacting point portion 13a, and a constantly closed fixed contacting point portion 14a by insert molding a common fixed contacting point terminal 12, a constantly opened fixed contacting point terminal (not shown), and a constantly closed fixed contacting point terminal (not shown) cut out from a lead frame (not shown).

The lower shield plate 20 forms an upstanding wall (not shown) by punching out a conductive plate-shaped body through press working, and bending and raising a peripheral edge portion so as to be connectable to an upper shield plate 40, to be hereinafter described. Furthermore, the lower shield plate 20 has a return spring 21 welded and integrated at a central part of a bottom surface. Ends 22, 23 of the return spring 21 are respectively pressure contacted to lower end faces of the movable contacting point blocks 30, 35, to be hereinafter described, and biased to an upper side.

The movable contacting point blocks 30, 35 are obtained by insert molding each movable contacting pieces 31, 36 made from conductive plate spring. The ends of the movable contacting piece 31 can be brought into contact with and separated from the common fixed contacting point portion 12a and the constantly opened fixed contacting point portion 13a. The ends of the movable contacting piece 36 can be brought into contact with and separated from the common fixed contacting point portion 12a and the constantly closed fixed contacting point portion 14a.

The upper shield plate 40 is made of a conductive material of a rectangular plate shape, where the upper ends of the movable contacting point blocks 30, 35 project out in a freely upward and downward moving manner from insertion holes 41, 43 formed at two locations in a longitudinal direction. The upper shield plate 40 is arranged in a projecting manner with earth contacting point portions 42, 42 at positions facing each other with the insertion hole 41 in between, and is arranged in a projecting manner with earth contacting point portions 44, 44 at positions facing each other with the insertion hole 43 in between. A plurality of earth terminals 45 are extended downward from the peripheral edge portion at the upper shield plate 40.

The electromagnetic block 60 is formed by winding a coil 63 to a spool 62 assembled with an iron core 61 and a coil terminal (not shown), and then assembling a permanent magnet 64. The iron core 61 has a cross-section of a substantially hat shape, where the lower surface of both ends serve as magnetic pole portions 65, 66.

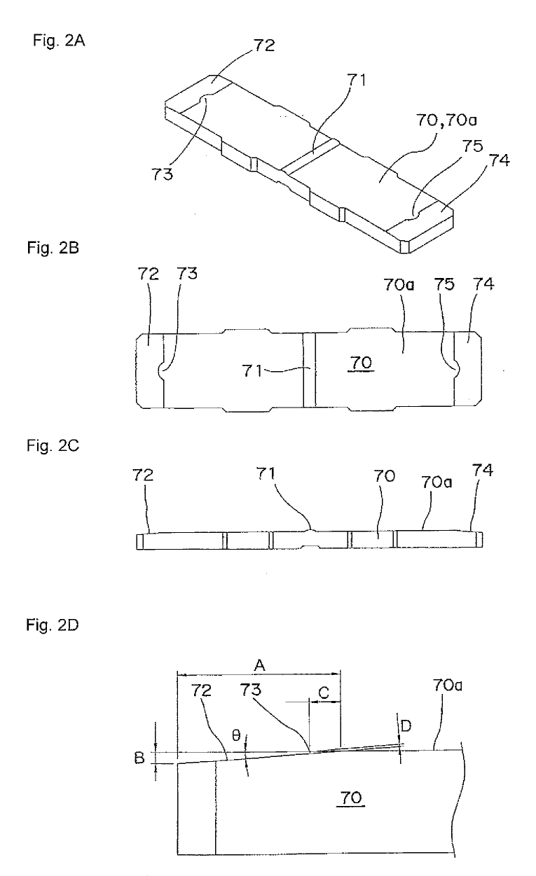

As shown in FIGS. 2 to 4, the movable iron piece 70 is made of a plate-shaped magnetic material, where the central part is subjected to extrusion processing so that a protrusion 71, which acts as a rotation supporting point, is arranged in a projecting manner on an attraction surface 70a side. At tapered surfaces 72, 74 formed by press working both ends of the attraction surface 70a, the movable iron piece 70 is arranged in a projecting manner with contacting portions 73, 75 of a semicircular shape in plane view.

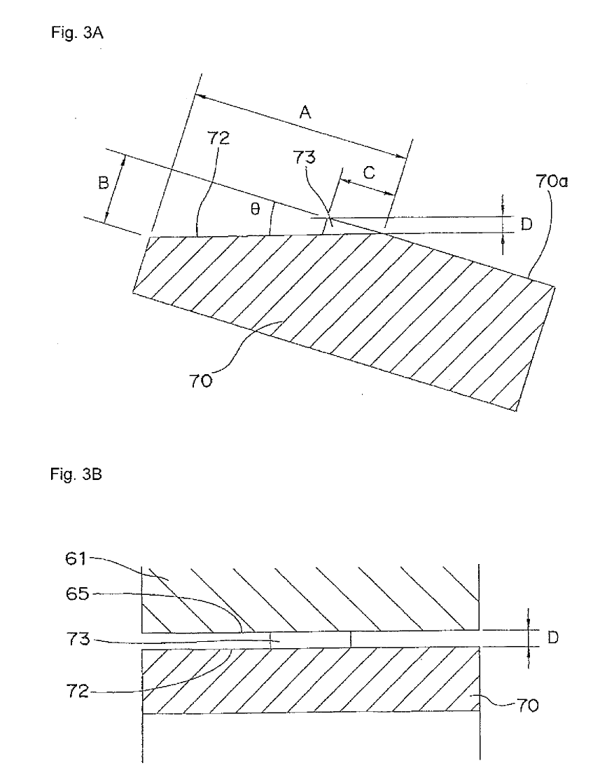

In particular, as shown in FIG. 3A, the tapered surface 72 is formed at an inclination angle θ, and the contacting portion 73 is continuous to and in flush with the attraction surface 70a of the movable iron piece 70. As shown in FIG. 3B, an opposing distance D between the magnetic pole portion 65 of the iron core 61 and the tapered surface 72 of the movable iron piece 70 is determined by the inclination angle θ (=B/A) of the tapered surface 72 and a length dimension C of the contacting portion 73. That is,

Height dimension D of contacting portion=C×sin θ

θ=tan⁻¹(B/A)

Thus, a press surface for forming the tapered surface 72 merely needs to be formed in a die, and a recess does not need to be formed in the press die as in the related art. As a result, a structure of the die is simplified, variations in the height dimension D of the contacting portions 73, 75 are eliminated, and an electromagnetic relay without variations in an operation property is obtained.

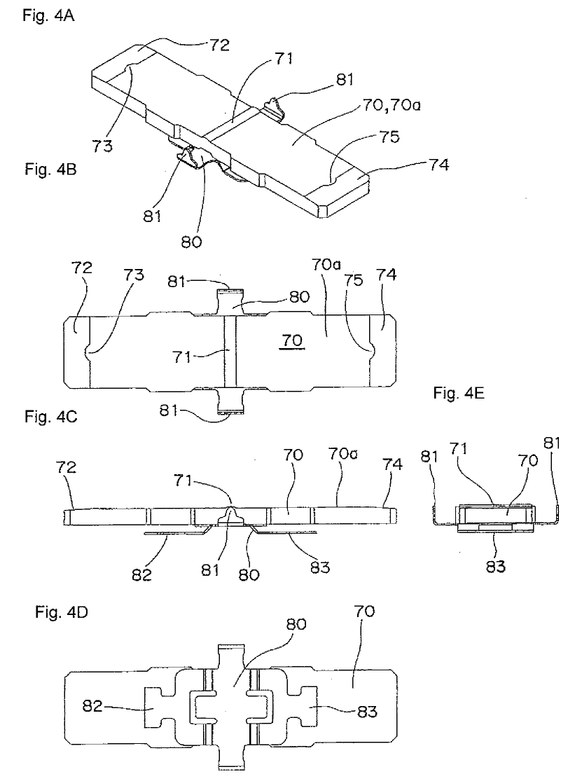

Furthermore, as shown in FIG. 4, the movable iron piece 70 is welded and integrated with a pushing spring 80 at the central part of the lower surface. The pushing spring 80 has a substantially cross-shape in plane view, where the opposing ends are bent and raised at a substantially right angle to form supporting projections 81, 81. The supporting projection 81 has a substantially triangular shape in front view so as to be automatically aligned, and a vertex thereof is arranged on the same line as the vertex of the protrusion 71 of the movable iron piece 70. Thus, an advantage in that a rotation of the movable iron piece 70 becomes a smooth rotation is obtained. Press working is performed on the remaining opposing ends of the pushing spring 80 to form elastic arms 82, 83.

An operation of the electromagnetic relay configured as above will be described.

First, if voltage is not applied to the coil 63, the contacting portion 73 positioned at one end of the movable iron piece 70 is brought into contact with the magnetic pole portion 65 of the iron core 61 by a magnetic force of the permanent magnet 64. Thus, the elastic arm 83 of the pushing spring 80 pushes down the movable contacting point block 35. As a result, both ends of the movable contacting piece 36 are brought into contact with the common fixed contacting point portion 12a and the constantly opened fixed contacting point portion 14a against the spring force of the other end 23 of the return spring 21. The movable contacting point block 30 is biased to the upper side by one end 22 of the return spring 21, and both ends of the movable contacting piece 31 are respectively brought into contact with the earth contacting point portions 42, 42 of the upper shield plate 40.

If a voltage is applied to the coil 63 in a direction of canceling out a magnetic flux of the permanent magnet 64, the magnetic pole portion 66 of the iron core 61 attracts the other end of the movable iron piece 70, and the movable iron piece 70 rotates with the vertex of the protrusion 71 as the rotation supporting point. The elastic arm 82 of the pushing spring 80 thus pushes down the movable contacting point block 30 against the spring force of one end 22 of the return spring 21. As a result, the movable contacting point block 30 lowers, and both ends of the movable contacting piece 31 respectively come into contact with the common fixed contacting point portion 12a and the constantly opened fixed contacting point portion 13a. The movable contacting point block 35 is pushed up by the spring force of the other end 23 of the return spring 21, and both ends of the movable contacting piece 36 respectively open from the common fixed contacting point portion 12a and the constantly closed fixed contacting pint portion 14a, and then come into contact with the earth contacting point portions 44, 44 of the upper shield plate 40. Thereafter, the contacting portion 75 of the movable iron piece 70 is attracted to the magnetic pole portion 66 of the iron core 61.

When application of the voltage to the coil 63 is stopped, a magnetic balance of the electromagnet device 50 is imbalanced, where the attractive force by the magnetic pole portion 65 of the iron core 61 is stronger than the attractive force by the magnetic pole portion 66. Thus, the movable iron piece 70 rotates in the direction opposite to the above and the elastic arm 83 of the pushing spring 80 pushes down the movable contacting point block 35, where one end 22 of the return spring 21 pushes up the movable contacting point block 30. As a result, both ends of the movable contacting piece 36 are brought into contact with the common fixed contacting point portion 12a and the constantly closed fixed contacting point portion 14a, whereas both ends of the movable contacting piece 31 are brought into contact with the earth contacting point portions 42, 42 of the upper shield plate 40 and return to the original state.

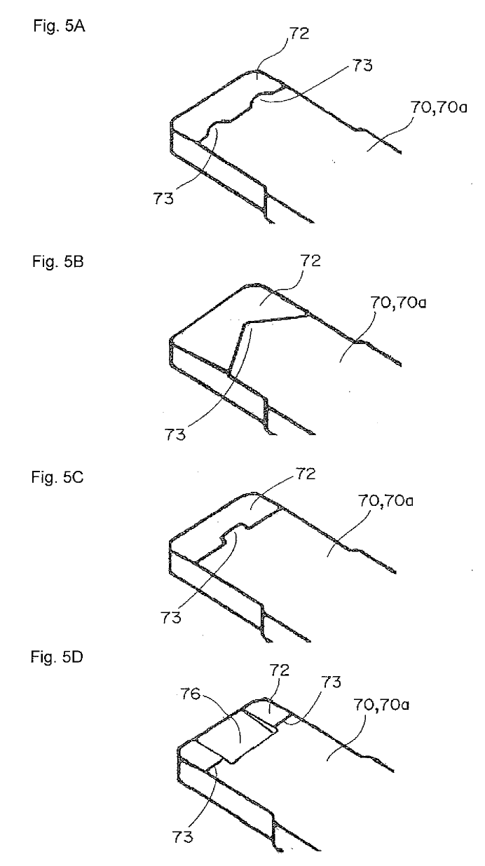

As another embodiment of the movable iron piece 70, a pair of contacting portions 73, 73 of a semicircular shape in plane view may be arranged side by side at the tapered surface 72 (a second embodiment), as shown in FIG. 5A; the contacting portion 73 of a triangular shape in plan view may be formed at the tapered surface 72 (a third embodiment), as shown in FIG. 5B; or the contacting portion 73 of a square shape in plan view may be formed at the tapered surface 72 (a fourth embodiment), as shown in FIG. 5C. Furthermore, a recess 76 may be formed at the central part of the tapered surface 72, as shown in FIG. 5D to form a pair of contacting portions 73, 73 at both side edge portions of the tapered surface 72 (a fifth embodiment).

The electromagnet device is not limited to a device including a seesaw type movable iron piece, and may be a pulsating-type movable iron piece. The contacting portion is not limited to being arranged at both ends of the movable iron piece, and may be arranged at only one end, or may be respectively arranged at the ends on the front and back surfaces of the movable iron piece.

It should be apparent that the electromagnet device according to the present invention is not limited to being applied to the electromagnetic relay, and may also be applied to other electric equipment.

1. An electromagnet device comprising:
a movable iron piece comprising an end that is operable to contacting and separate to and from a magnetic pole portion of an iron core; wherein
the movable iron piece rotates based on magnetization and demagnetization of a coil wound around the iron core,
a tapered surface is formed on at least one end of an attraction surface of the movable iron piece, which attracts to and separates from the magnetic pole portion of the iron core, and
at least one contacting portion that is in flush with and continuous to the attraction surface and in contact with the magnetic pole portion of the iron core is arranged in a projecting manner on the tapered surface.

2. An electromagnet device comprising:
a movable iron piece comprising an end that is operable to contact and separate to and from a magnetic pole portion of the iron core; wherein
the movable iron piece rotates based on magnetization and demagnetization of a coil wound around the iron core,
a tapered surface is formed on at least one end of an attraction surface of the movable iron piece, which attracts to and separates from the magnetic pole portion of the iron core, and
at least one recess is formed at the tapered surface to arrange at least one contacting portion that is in flush with and continuous to the attraction surface and in contact with the magnetic pole portion of the iron core.

3. The electromagnet device according to claim 1, wherein the tapered surface is a curved surface.

4. The electromagnet device according to claim 1, wherein the contacting portion that is in flush with and continuous to the attraction surface is arranged in a projecting manner at the tapered surface formed at both ends of the attraction surface of the movable iron piece.

5. The electromagnet device according to claim 2, wherein the tapered surface is a curved surface.

6. The electromagnet device according to claim 2, wherein the contacting portion that is in flush with and continuous to the attraction surface is arranged in a projecting manner at the tapered surface formed at both ends of the attraction surface of the movable iron piece.
